(19) United States
(12) Patent Application Publication
(10) Pub. No.: US 2007/0134980 A1
(43) Pub. Date: Jun. 14, 2007

(54) CRIMP SLEEVE CONNECTOR HAVING CRIMP INDICATOR

(75) Inventors: Steven Allen Poll, Zeeland, MI (US); Ronald Mark Dalessandro, Ryron Center, MI (US); Russel Christopher Six, Weat Olive, MI (US)

Correspondence Address: Thomas Moga;Butzel Long, STONERIDGE WEST, 41000 WOODWARD AVENUE, BLOOMFIELD HILLS, MI, 48304, US

(73) Assignee: TRANS-MATIC MANUFACTURING CO., INC., Holland, MI (US)

(21) Appl. No.: 11/678,332

(22) Filed: Feb. 23, 2007

Related U.S. Application Data
(63) Continuation-in-part of application No. 10/921,536, filed on Aug. 18, 2004.
(60) Provisional application No. 60/775,890, filed on Feb. 23, 2006.
(60) Provisional application No. 60/814,112, filed on Jun. 16, 2006.
(60) Provisional application No. 60/852,162, filed on Oct. 17, 2006.

(51) Int. Cl. H01R 9/05

(52) U.S. Cl. 439/585

(57) ABSTRACT

A crimp sleeve connector is provided for the secure connection of a tube and a fitting. The crimp sleeve connector is substantially positionable on the fitting and the tube is inserted between the fitting and the crimp sleeve connector. The connector includes a crimp ear which extends through the body of the crimp sleeve connector. At least one o-ring is fitted over the fitting in such a position that when the tube, fitting and crimp sleeve connector are in place the o-ring functions to maintain a fluid-tight seal. An alternative embodiment of the crimp sleeve connector includes a crimp indicator in the form of a band which falls away after crimping, thus allowing visual confirmation that the crimp ear has been crimped.

### RELATED APPLICATIONS

This application is a continuation-in-part of U.S. Ser. No. 10/921,536, filed Aug. 18, 2004, and claims priority to U.S. Provisional Patent Application Ser. No. 60/775,890, filed Feb. 23, 2007, U.S. Provisional Patent Application Ser. No. 60/814,112, filed Jun. 16, 2006, and U.S. Provisional Patent Application Ser. No. 60/852,162, filed Nov. 17, 2006.

### TECHNICAL FIELD

The present invention relates generally to sleeve connectors for attaching a tube to a fitting. More particularly, the present invention relates to crimp sleeve connectors that can be crimped to attach a tube to a fitting. The present invention further relates to indicators for use with such crimp sleeve connectors for providing positive confirmation that the connector has been crimped.

### BACKGROUND OF THE INVENTION

Fluid carrying conduits are used in a variety of environments including building structures such as homes and manufacturing facilities as well as in transportation vehicles such as automobiles. The conduits are provided in a variety of shapes and sizes and typically involve polymerized pipes and tubes that are connected to pipe fittings. The pipes and tubes are fixed to the fittings through a variety of methods, including, for example, compression clamps. The compression clamps bring the pipe or tube into close physical contact with the fitting. To accomplish this measure the compression clamps must be compressed or crimped around the tube or pipe. Whether or not the tube is successfully attached depends on the arrangement of the compression clamp and on the skill of the installer.

Because of the great number of compression clamps used in a variety of settings it is important that the installer is able to easily and quickly attach the tube to the fitting at the correct orientation. Too much overlap of the tube onto the fitting results in wasted tubing whereas too little overlap of the tube onto the fitting risks an improper connection. Once the tube is properly attached to the fitting it is also necessary that the compression clamp be readily compressed.

While some known methods of compression clamping of a tube to a fitting have certain advantages, as in so many areas of vehicle technology, there is room in the art of compression clamps for improving both the accuracy and ease of connection.

### SUMMARY OF THE INVENTION

The present invention provides a crimp sleeve connector for connecting and maintaining the connection between a pipe fitting and a component such as a fitting. The crimp sleeve connector includes a crimp band formed from a metal and a body formed from a polymerized material. The crimp band includes a band portion and a crimp ear. The crimp ear extends from the band portion and includes a pair of opposed crimping walls and a bridge connecting the walls. The body includes an upper, tube receiving end and a lower, narrow end for attachment to the fitting. The upper end has a bevel which allows the installer to more easily insert the tube into the body. The lower end has a series of legs which terminate in flanges. The flanges interlock with a channel formed on the fitting. This will connect the crimp sleeve connector and the fitting together as an assembly saving the installer valuable time during installation. Inward of the flanges is a shoulder against which the tube abuts upon full insertion of the tube into the body of the crimp sleeve connector.

To provide a fluid-tight seal between the fitting and the tube one or more O-rings is provided on the fitting. When the crimp band is crimped the tube is pressed against the fitting and the O-rings are squeezed, thus forming a fluid-tight seal.

The body of the crimp sleeve connector also includes an internal groove formed on the inner wall of the body. The band portion of the crimp band nests in the groove. The crimp sleeve connector body also includes a window formed in one of its walls. When the crimp band is positioned within the crimp sleeve connector body the crimp ear extends substantially through the window.

To use the crimp sleeve connector of the present invention, the installer places the crimp sleeve connector onto the fitting until the flanges of the body engage the channel of the fitting. The crimp sleeve connector is thus installed on the fitting. The installer next inserts the tube into the crimp sleeve connector body until the end of the tube abuts the shoulder formed within the crimp sleeve connector body. At that point the tube is fully inserted into the crimp sleeve connector body.

Crimping of the crimp sleeve connector is effected using a crimping tool having a pair of opposed jaws for engagement with the crimping walls of the crimp ear. When the installer applies force to the crimping tool such that the opposed jaws press against the crimping walls, the crimping walls are moved in toward one another and the diameter of the crimping band is thus reduced. The reduced diameter causes the tube to squeeze inwardly against the fitting.

The present invention also provides a system by which the installer can know visually and with certainty that the crimp sleeve connector has been crimped. To this end a crimp indicator is provided around the crimp sleeve connector. The crimp indicator is specifically positioned over the crimp ear. The crimp indicator is composed of an elastic and flexible polymerized material in the form of a band or tape. The crimp indicator is preferably stretched over the crimp sleeve connector

Once the crimping tool is placed on the clamp connector the tool is manipulated by squeezing, in addition to crimping the crimp ear the opposed jaws of the crimping tool cut through the flexible band, thus freeing the band from the clamp connector and indicating to the installer that the clamp connector has been crimped and verifies that the crimp operation has been completed by the installer.

The arrangement of the present invention offers a variety of advantages over the prior art.

The present invention has several useful features when compared with the prior art. For example, the crimp sleeve connector can be used to attach many different types of pipe made from a variety of materials, such as plastic, rubber, and/or a combination of plastic and metal or multi-layer pipes.

In addition, the fitting can be made from any type of metal or plastic material. The fitting can include one or more barbs of any shape or design as well as o-rings in addition to or instead of the barbs.

The indicator system provides the installer with instant recognition of the state of the crimping of the crimp band. The crimp band indicator of the present invention may be readily attached to the crimp sleeve connector at the manufacturing stage or the crimp band indicator may be attached to a crimp sleeve connector as an after-market indicator. The crimp band indicator of the present invention is also inexpensive to produce and to operate.

Other advantages and features of the invention will become apparent when viewed in light of the detailed description of the preferred embodiments when taken in conjunction with the attached drawings and the appended claims.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 illustrates a perspective view of the assembled tube, fitting and crimp sleeve connector of the present invention;

FIG. 2 shows a sectional view of the assembled tube, fitting, and crimp sleeve connector shown in FIG. 1;

FIG. 3 is an exploded view of the components shown in FIG. 2;

FIG. 4 is a view similar to that of FIG. 3 but showing each illustrated component in section;

FIG. 5 illustrates a perspective view of a modified version of the assembled tube, fitting and crimp sleeve connector of FIGS. 1-4 with the crimp sleeve connector having a crimp band indicator in position prior to crimping;

FIG. 6 is a sectional view of the assembled tube, fitting and crimp sleeve connector shown in FIG. 5;

FIG. 7 is an exploded view of the tube, fitting and crimp sleeve connector with the connector having the crimp band indicator of FIGS. 5 and 6;

FIG. 8 is an exploded side view of the assembled tube, fitting and crimp sleeve connector with crimp band indicator of FIGS. 5-7 but showing the components in sectional view;

FIG. 9 is a view of the first step in using a crimping tool to crimp the crimp sleeve connector while simultaneously grasping the crimp band indicator;

FIG. 10 is a view of the second step in using the crimping tool to crimp the crimp sleeve connector while simultaneously breaking the crimp band indicator with the crimping tool; and

FIG. 11 is a view of the third step in using the crimping tool to crimp the crimp sleeve connector with the crimp band indicator having been broken.

### DETAILED DESCRIPTION OF THE PREFERRED EMBODIMENT

In the following figures, the same reference numerals will be used to refer to the same components. In the following description, various operating parameters and components are described for one constructed embodiment. These specific parameters and components are included as examples and are not meant to be limiting.

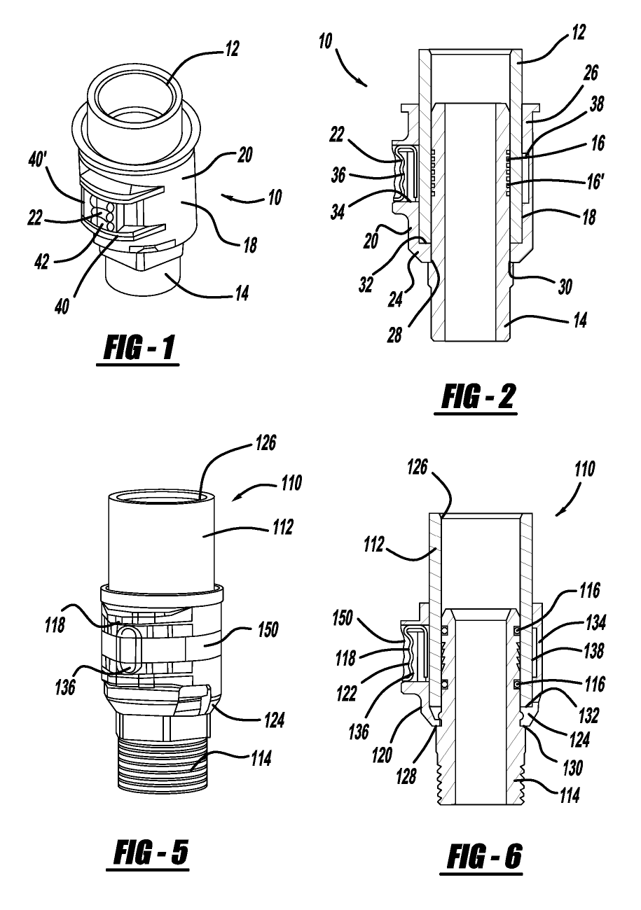

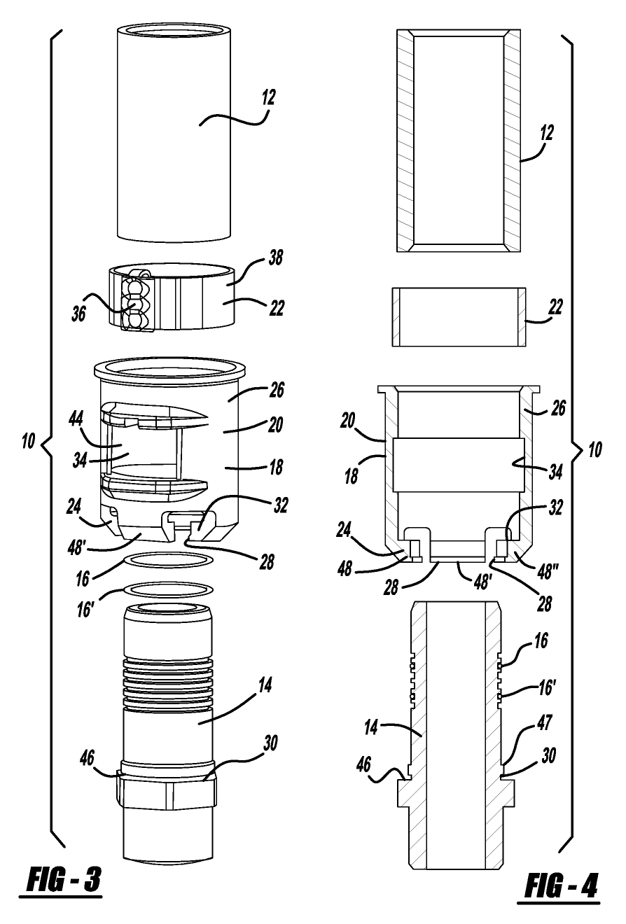

With reference to FIG. 1, a perspective view of the assembled tube, fitting and crimp sleeve connector, generally illustrated as 10, is shown. It is to be understood that the illustrated size and shape of the assembly 10 is shown for illustrative purposes and is not intended to be limiting. The assembly 10 is illustrated in cross-section in FIG. 2.

Referring to both FIG. 1 and FIG. 2, the assembly 10 includes a tube 12 that may be composed of a variety of materials including plastic or vinyl. In addition, the tube 12 may have a core composed of a metal, such as aluminum, and have a wrapping of a polymerized material.

The assembly 10 further includes a fitting 14 to which the tube 12 is connected. The fitting 14 is illustrated as being of the threaded type. However it is to be understood that the fitting 14 may be of a variety of types and designs. In addition, the fitting 14 may be composed of a wide variety of materials including a plastic, a nylon or a metal. A pair of spaced apart O-rings 16, 16′ is fitted near the connected end of the fitting 14 in channels formed in the fitting 14. The O-rings 16, 16′ may be made from a known variety of polymerized material and are provided to form a fluid-tight seal between the tube 12 and the fitting 14. While two O-rings 16, 16′ are shown it is to be understood that a single o-ring may be used as well as more than the illustrated two o-rings. In addition, the one or more O-rings may be placed along the fitting 14 at different locations other than those shown. In addition, the O-rings may alternatively be provided on the inside of the tube 12. The object of the O-rings and their placement is to provide a fluid-tight seal between the tube 12 and the fitting 14.

Holding the tube 12 and the fitting 14 together is a crimp sleeve connector 18. The crimp sleeve connector 18 includes a body 20 and a crimp band 22. The body 20 is preferably composed of a polymerized material such as a plastic. The crimp band 22 is formed from a metal.

The body 20 of the crimp sleeve connector 18 includes a narrow end 24 and a wide end 26. The wide end 26 includes a slight bevel as illustrated. The narrow end 24 includes an internal flange 28 which is fittable into a channel 30 radially formed on the fitting 14. Formed inwardly of the internal flange 28 is a shoulder 32 which acts as a wall so that the end of the tube 12 stops on insertion into the crimp sleeve connector 18.

The crimp band 22 is provided in a groove 34 formed radially in the inner wall of the body 20. The crimp band 22 includes a crimp ear 36 and a band portion 38. The crimp ear 36 extends radially outwardly from the band portion 38. The crimp ear 36 includes a pair of spaced apart crimp tool-receiving walls 40 and 40′ of which one, wall 40, is seen in FIG. 1 and FIG. 2. The crimp tool-receiving walls 40 and 40′ are joined by a bridge 42. When the teeth of a crimp tool (not shown) are applied to either side of the crimp tool-receiving walls 40 and 40′ and pressure is applied to the tool, the walls 40 and 40′ are pushed toward one another and the band portion 38 is compressed against the tube 12, thereby locking by compressive force the tube 12 against the fitting 14. The method of fitting is described and illustrated more fully in co-pending U.S. Ser. No. 10/921,536, incorporated herein by reference.

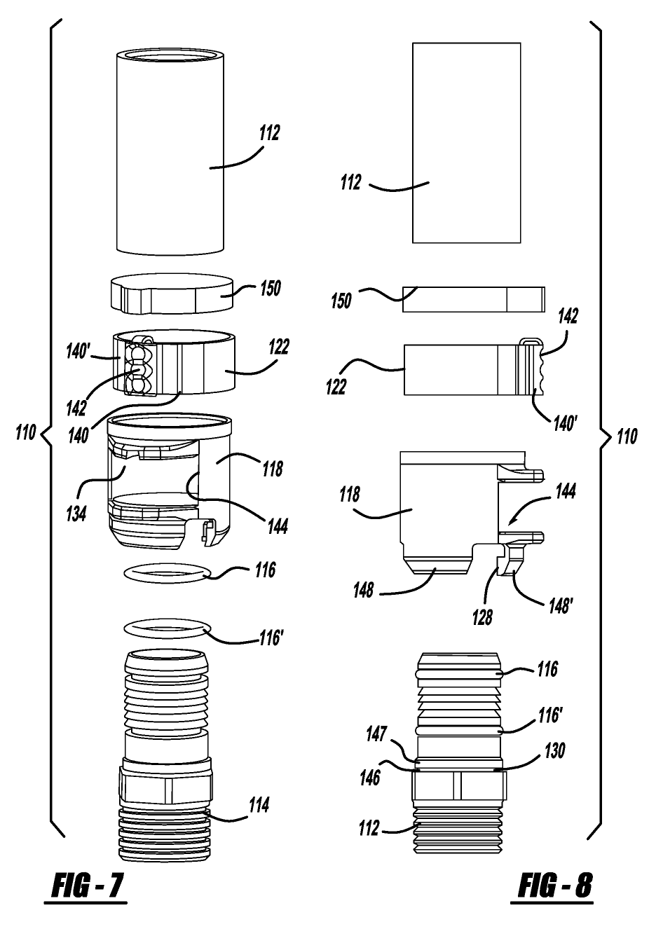

The tube 12, fitting 14, crimp band 22, and body 20 are shown in exploded views in FIG. 3 and FIG. 4. In FIG. 3 the exploded components are shown whole while in FIG. 4 the components are each shown in section. These views help to illustrate some of the details of the construction of the present invention. With regard to the body 20, a window 44 is defined therein through which the crimp ear 36 passes when the crimp band 22 is positioned within the groove 34 of the body 20. Also illustrated in greater detail is the channel 30 and its formation adjacent a radial wall 46 which functions as a stop against which the body 20 is braced when in position on the fitting 14. The other wall of the channel 30 is a radial shoulder 47. The radial wall 46 and the radial shoulder 47 define the channel 30 therebetween.

To use the crimp sleeve connector 18 to connect the tube 12 and the fitting 14, the crimp sleeve connector 18 (with the band 22 in place in the groove 34 of the body 20) is first placed on the fitting 14 by a sliding movement followed by a snap fit. Specifically, and to this end, both FIG. 3 and FIG. 4 also provide an advantageous view of the construction of the narrow end 24 of the body 20. Particularly, the narrow end 24 includes a plurality of legs 48, 48′, and 48″. Because the body 20 is composed of a polymerized material, the legs 48, 48′ and 48″ are somewhat flexible in relation to the body 20. This construction allows for the flange 28 (formed on each of the legs 48, 48′ and 48″) to resiliently move outwardly and over the radial shoulder 47 of the fitting 14 as the body is inserted onto the crimp sleeve connector 18 is fitted on the fitting 14. The flanges 28 of each of the legs 48, 48′ and 48″ snap fit into the channel 30.

Once the crimp sleeve connector 18 is positioned on the fitting 14, the tube 12 is inserted into the wide end 26 of the body 20. The tube 12 is pushed into the body 20 until the end of the tube 12 abuts the shoulder 32 at which point inward movement of the tube 12 into the body 20 is halted.

Thereafter the crimping tool is used to crimp the crimp ear 36 and the band 22 is drawn tight against the tube 12 which, in turn, is drawn tight against the fitting 14. This arrangement, in conjunction with the O-rings 16 and 16′, forms a fluid-tight connection between the tube 12 and the fitting 14.

It may be desired by the user to readily visualize whether or not the crimp sleeve connector 18 has been crimped. Accordingly, a variation of the invention shown in FIGS. 1 through 4 is illustrated in FIGS. 5 through 11 in which an indicator system is provided on the crimp sleeve connector.

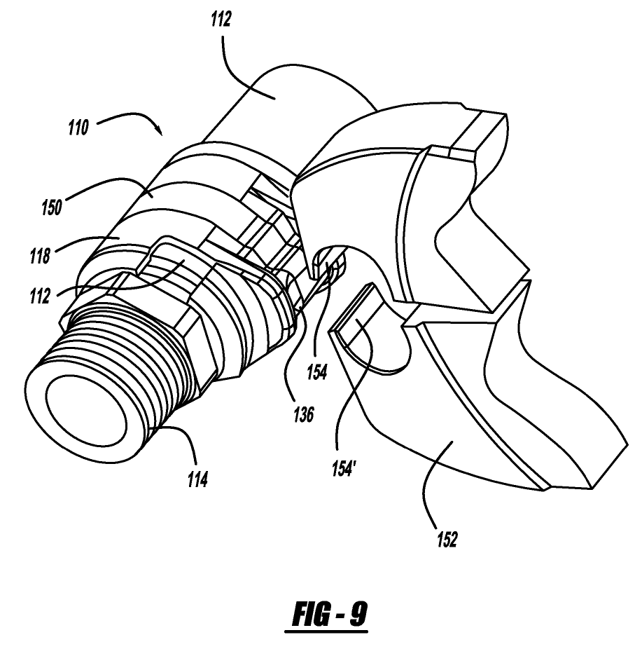

With reference to FIG. 5 and FIG. 6, an alternate embodiment of the present invention is illustrated as an assembly 110 which includes a tube 112 which is composed of the same materials as the tube 12. The assembly 110 further includes a fitting 114 to which the tube 112 is connected. A pair of spaced apart O-rings 116, 116′ is provided on the fitting 114.

A crimp sleeve connector 118 is provided and includes a body 120 and a crimp band 122. The body 120 of the crimp sleeve connector 118 includes a narrow end 124 and a wide end 126. The narrow end 124 includes an internal flange 128 which is fittable into a channel 130 radially defined in the fitting 114. A shoulder 132 is formed inwardly of the internal flange 128. The shoulder 132 is a wall against which the end of the tube 112 is halted when the tube 112 is inserted into the crimp sleeve connector 118.

A groove 134 is formed inside of the body 120 to receive and retain the crimp band 122. A crimp ear 136 extends from a band portion 138 of the crimp band 122.

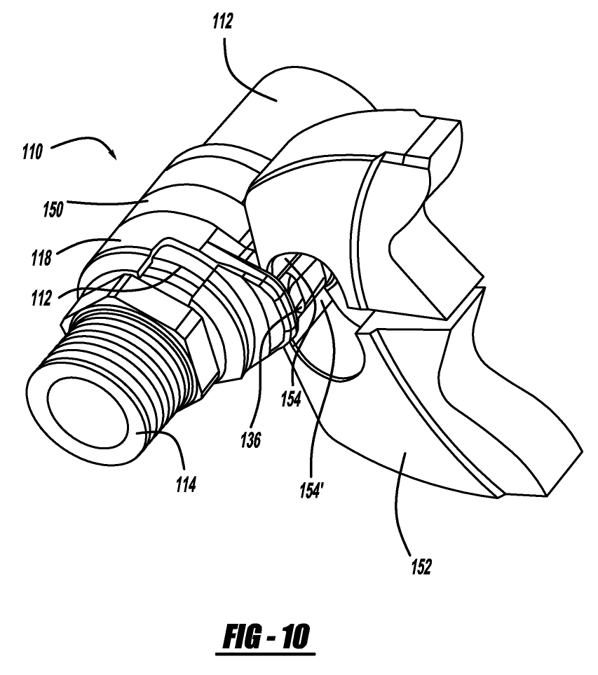

As illustrated more clearly in FIG. 7 and FIG. 8 which both illustrated exploded views of the assembly 110, the crimp ear 136 includes a pair of spaced apart crimp tool-receiving walls 140 and 140′ which are joined by a bridge 142. Referring to FIG. 7 and FIG. 8, a window 144 is formed through the body 120 through which the crimp ear 136 is passed when the crimp band 122 is positioned within the groove 134 of the body 120. The construction of the channel 130 is also clearly shown in FIG. 7 and FIG. 8. The channel 130 is formed between a radial wall 146 and a radial shoulder 147. A pair of opposed walls 145 and 145′ are formed in the body 120. The pair of opposed walls 145 and 145′ define two opposed ends of the window 144 and provide a slot which guides the jaws of the crimping tool (shown in FIGS. 9 through 11 and discussed in relation thereto). The opposed walls 145 and 145′ thus enable the operator to more readily locate and apply appropriate pressure to the crimping ear 136, an arrangement which provides great time savings and improved crimping.

Also visible in FIG. 7 and FIG. 8 are a pair of legs 148 and 148′. The construction and function of the legs 148 and 148′ are essentially the same as construction and function of the legs 48, 48′ and 48″. Each of the legs 148 and 148′ includes a flange 128. The flanges 128 snap fit into the channel 130 upon attachment of the crimp sleeve connector 118 onto the fitting 114.

Assembly of the fitting 114, the tube 112 and the crimp sleeve connector 118 is the same as discussed above with respect to the assembly 10.

An additional and distinguishing feature of the embodiment of the crimp sleeve connector illustrated in FIGS. 5 through 8 is the addition of an indicator system which is provided to make clear to the installer by a quick visual glance whether or not the crimp sleeve connector has been crimped. To accomplish this, a crimp indicator 150 is provided around the crimp sleeve connector 118 and is in part specifically positioned over the crimp ear 136. The crimp indicator 150 is preferably composed of an elastic and flexible polymerized material in the form of a band or tape. The crimp indicator 150 is preferably stretched over the crimp sleeve connector 118. When the crimp sleeve connector 118 is in position on the tube 112 and the fitting crimp indicator 150 is missing from the crimp sleeve connector 118 it can be presumed by the installer that the crimp sleeve connector 118 has already been crimped.

The crimping of the crimp sleeve connector 118 and the substantially simultaneous breaking and release of the crimp indicator 150 is illustrated in step-wise views in FIGS. 9 through 11 in which a crimping tool 152 is shown. The crimping tool 152 includes a pair of opposed crimping and cutting jaws 154 and 154′. The crimping tool 152 shown is for illustrative purposes and it is to be understood that a single crimping tool 152 may be used to crimp a wide variety of connectors regardless of the width of the crimp ear. This flexibility enables easier installation of the connector of the present invention in that the installer need only rely on one crimping tool 152 rather than several.

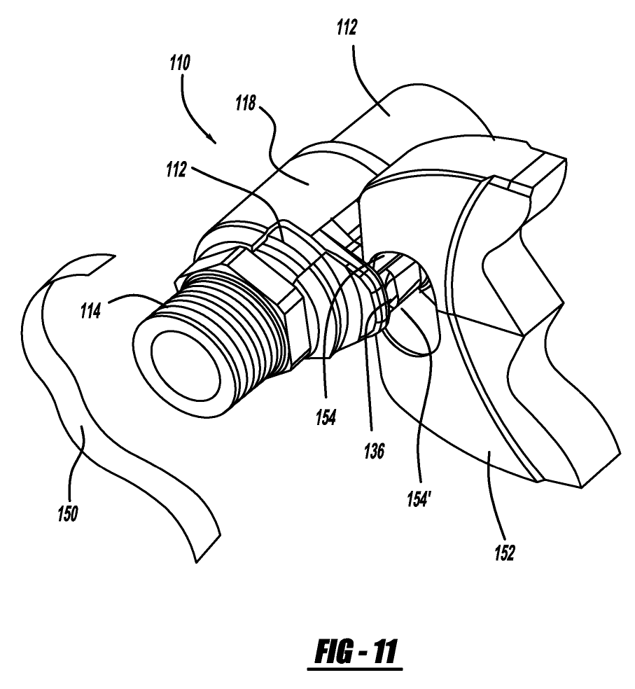

In FIG. 9 the crimping tool 152 is shown spaced apart from the assembly 110 and the crimp band indicator 150. In FIG. 10 the crimping tool 152 is shown in position on the crimp ear 136 and the overlapping crimp indicator 150 while crimping and cutting is being undertaken by the opposed jaws 154 and 154′. In FIG. 11 the crimping tool 152 is shown as having completed the crimping and cutting operation whereby the crimp indicator 150 has been cut and released and the crimp sleeve connector 118 has been crimped and is positioned so as to hold the tube 112 in place in the fitting 114.

The foregoing discussion discloses and describes a exemplary embodiments of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A crimp sleeve connector for connecting a tube and a fitting, the fitting having a radial channel, the connector comprising:
a crimp band having a band portion and a crimp ear extending from said band portion;
a connector body having a tube inserting end and a fitting inserting end, said connector body further having an internal band portion groove and a crimp ear window formed therein, said connector body further having a shoulder against which the tube abuts and a flange for engagement with the radial channel of the fitting.

2. The crimp sleeve connector of claim 1 wherein said crimp ear is defined by a pair of spaced apart walls and a bridge connecting said pair of spaced apart walls.

3. The crimp sleeve connector of claim 1 wherein said fitting inserting end includes at least two legs.

4. The crimp sleeve connector of claim 1 further including at least one o-ring attached to said fitting.

5. The crimp sleeve connector of claim 1 further including a crimp indicator.

6. The crimp sleeve connector of claim 5 in which said indicator is a severable band at least partially fitted over said crimp ear.

7. The crimp sleeve connector of claim 6 in which said band is substantially elastic.

8. The crimp sleeve connector of claim 1 in which said tube inserting end of said connector body has a bevel.

9. A fluid line connector assembly including:
a tube;
a fitting, said fitting having a radial wall;
a crimp sleeve connector for connecting said tube and said fitting, said crimp sleeve connector having a crimp band and a connector body, said crimp band having a band portion and a crimp ear substantially extending from said band portion, said connector body having a window through which said crimp ear at least partially extends, said connector body further including a fitting inserting end which is abuttable against said radial wall of said fitting when said fitting is inserted into said crimp sleeve connector.

10. The fluid line connector assembly of claim 9 in which said connector body further includes an internal band portion groove.

11. The fluid line connector assembly of claim 9 in which said connector body further includes a flange extending from said lower end and in which said fitting includes a channel defined adjacent said radial wall, said flange being engageable with said channel.

12. The fluid line connector assembly of claim 9 wherein said crimp ear is defined by a pair of spaced apart walls and a bridge connecting said pair of spaced apart walls.

13. The fluid line connector assembly of claim 9 wherein said fitting inserting end of said crimp sleeve connector includes at least two legs.

14. The fluid line connector assembly of claim 9 wherein said fitting includes at least one o-ring.

15. The fluid line connector assembly of claim 9 wherein said crimp sleeve connector further includes a crimp indicator.

16. The fluid line connector assembly of claim 15 in which said indicator is a severable band at least partially fitted over said crimp ear.

17. The fluid line connector assembly of claim 16 in which said band is substantially elastic.

18. A fluid line connector assembly including:
a tube;
a fitting, said fitting having a radial wall;
a crimp sleeve connector for connecting said tube and said fitting, said crimp sleeve connector having a crimp band, a connector body, and a breakable crimp indicator fitted at least partially over said crimp band.

19. The fluid line connector assembly of claim 18 in which said crimp band of said crimp sleeve connector has a band portion and a crimp ear substantially extending from said band portion.

20. The fluid line connector assembly of claim 19 in which said connector body has a window through which said crimp ear at least partially extends and in which said connector body further includes a fitting inserting end which is abuttable against said radial wall of said fitting when said fitting is inserted into said crimp sleeve connector.
